(19) United States
(12) Patent Application Publication
(10) Pub. No.: US 2012/0130010 A1
(43) Pub. Date: May 24, 2012

(54) RAILCAR SHOCK ABSORBER RUBBER COMPOSITION

(75) Inventor: Toshio Azechi, Osaka-shi (JP)

(73) Assignee: TOYO TIRE & RUBBER CO., LTD., Osaka (JP)

(21) Appl. No.: 13/295,177

(22) Filed: Nov. 14, 2011

(30) Foreign Application Priority Data
Nov. 18, 2010 (JP) 2010-258083

(51) Int. Cl. C08L 7/00

(52) U.S. Cl. 524/575.5

(57) ABSTRACT

Provided is a railcar shock absorber rubber composition that can provide high cured rubber hardness and simultaneously achieve electrical insulating properties and suppression of a decrease in elastic modulus after strain loading, and includes a diene rubber as a main component, hydrous silicic acid or wet silica with a BET specific surface area of 70 to 130 m²/g, and carbon black with a DBP oil absorption of 130 cm³/100 g or less, wherein 30 to 100 parts by weight of the hydrous silicic acid or wet silica and 5 to 40 parts by weight of the carbon black are present based on 100 parts by weight of the total amount of the rubber component.

### BACKGROUND OF THE INVENTION

1. Field of the Invention

The present invention relates to a railcar shock absorber rubber composition that includes a diene rubber as a main component and is useful for forming a railcar rubber shock absorber capable of simultaneously achieving electrical insulating properties and suppression of a decrease in elastic modulus after strain loading.

2. Description of the Related Art

Rubber shock absorbers with various shapes and damping properties are commonly used in rail vehicles. For example, a bushing rubber shock absorber is attached as part of a power transfer link device between a body and a bogie. Such a rubber shock absorber absorbs the force generated by vertical and horizontal movement and produces a restoring force against the movement. It is important that rubber shock absorbers for use in rail vehicles should undergo little change with time in the static spring constant, which corresponds to the elastic modulus of the products.

In general, rubber vibration insulators for use at high temperature, such as those for automobiles, may have a problem in which the static spring constant of the rubber is increased by the influence of heat (see for example Japanese Patent Application Laid-Open (JP-A) No. 2005-194501 or the like). On the other hand, railcar rubber shock absorbers, which are not used at high temperature as often as automobile rubber vibration insulators, may have a problem in which a decrease in spring constant is caused by repetitive vibration-induced fatigue degradation rather than by heat hardening degradation due to repetitive vibration at high temperature.

In addition, railcar rubber shock absorbers are often required to have electrical insulating properties as well as to be inhibited from undergoing a decrease in spring constant. A technique for increasing the electrical insulating properties of a rubber shock absorber while maintaining its rubber hardness may include adding silica in place of carbon black, which is commonly added to shock absorber rubber. Unfortunately, the elastic modulus of silica-containing rubber tends to have a large amplitude dependence, in which even though the elastic modulus is high at very low amplitude, the elastic modulus becomes low at high amplitude, namely, the so-called Payne effect can be easily produced. In addition, the initial elastic modulus of silica-containing rubber tends to decrease with repeated strain loading relative to that of carbon black-containing rubber, namely, the so-called Mullins effect is significantly produced. Therefore, the fact is that it is difficult for railcar rubber shock absorbers to simultaneously achieve electrical insulating properties and suppression of a decrease in elastic modulus after strain loading.

### SUMMARY OF THE INVENTION

The present invention has been made in view of the above circumstances, and an object of the present invention is to provide a railcar shock absorber rubber composition that can provide high cured rubber hardness and simultaneously achieve electrical insulating properties and suppression of a decrease in elastic modulus after strain loading.

As a result of earnest studies to solve the above problems, the inventor has found that: (i) silica tends to be less dispersible in rubber than carbon black; (ii) due to such low dispersibility, the elastic modulus of rubber after strain loading tends to decrease; and (iii) such a decrease in elastic modulus leads to a decrease with time in the spring constant of a railcar rubber shock absorber. Based on the finding, it has been found that cured rubber obtained from a rubber composition containing silica with specific colloidal properties and carbon black in a specific weight ratio can simultaneously achieve electrical insulating properties and suppression of a decrease in elastic modulus after strain loading. The present invention, which has been accomplished as a result of the above studies, has the features described below to achieve the object.

Thus, the present invention is directed to a railcar shock absorber rubber composition including a diene rubber as a main component, hydrous silicic acid or wet silica with a BET specific surface area of 70 to 130 m²/g, and carbon black with a DBP oil absorption of 130 cm³/100 g or less, wherein 30 to 100 parts by weight of the hydrous silicic acid or wet silica and 5 to 40 parts by weight of the carbon black are present based on 100 parts by weight of the total amount of a rubber component.

The rubber composition contains the specified hydrous silicic acid or wet silica and carbon black in the specified ratio. A railcar rubber shock absorber obtained by curing such a rubber composition has high cured rubber hardness and simultaneously achieves electrical insulating properties and suppression of a decrease in elastic modulus after strain loading. It is considered that such advantageous effects are achieved for the reason described below.

The hydrous silicic acid or wet silica with a BET specific surface area in the above range has a relatively large particle size and a relatively small specific surface area and therefore has relatively low particle surface energy. In this case, the cohesion between the silica particles is relatively low, so that the silica particles can be easily dispersed in the rubber composition and in the railcar rubber shock absorber made of the cured rubber. As a result, even when vibration is repeatedly applied to the railcar rubber shock absorber, the decrease in elastic modulus (corresponding to static spring constant) can be suppressed. In addition, the carbon black with a DBP oil absorption in the above range has moderately low surface structure. Therefore, the addition of such carbon black makes it possible to increase the rubber hardness and electrical insulating properties of the railcar rubber shock absorber.

The railcar shock absorber rubber composition preferably satisfies the formula (I): X/Y≧1.1, wherein X represents the content of the silica, and Y represents the content of the carbon black. When the content ratio between the silica and the carbon black in the rubber composition is controlled in this range, the rubber hardness of the railcar rubber shock absorber can be increased, and electrical insulating properties and suppression of a decrease in elastic modulus after strain loading can be simultaneously achieved in a more balanced manner.

### DETAILED DESCRIPTION OF THE PREFERRED EMBODIMENTS

The railcar shock absorber rubber composition according to the present invention includes: a diene rubber as a main component; hydrous silicic acid or wet silica with a BET specific surface area of 70 to 130 m²/g; and carbon black with a DBP oil absorption of 130 cm³/100 g or less, wherein the diene rubber, the hydrous silicic acid or wet silica, and the carbon black are blended in a specific ratio.

The diene rubber may be any of natural rubber (NR) or synthetic diene rubber. Examples of synthetic diene rubber include polyisoprene rubber (IR), polybutadiene rubber (BR), styrene-butadiene rubber (SBR), butyl rubber (IIR), and acrylonitrile-butadiene rubber (NBR). The polymerization method for these synthetic diene rubbers or the microstructure of these synthetic diene rubbers is not restricted, and any of these synthetic diene rubbers may be used alone or in a blend with natural rubber and/or any other synthetic diene rubber. In an embodiment of the present invention, the diene rubber used is preferably any one or any blend of natural rubber (NR), styrene-butadiene rubber (SBR), and polybutadiene rubber (BR). Specifically, the term “includes (comprises) a diene rubber as a main component” as used herein means that based on 100 parts by weight of the total amount of the rubber component, the diene rubber is contained in an amount of 50 parts by weight or more, more preferably 70 parts by weight or more, even more preferably 100 parts by weight.

The hydrous silicic acid or wet silica used has a BET specific surface area of 70 to 130 m²/g. In order to more effectively suppress a decrease in elastic modulus after strain loading, hydrous silicic acid or wet silica with a BET specific surface area of 80 to 110 m²/g is preferably used. The content of the hydrous silicic acid or wet silica in the rubber composition is from 30 to 100 parts by weight, more preferably from 50 to 80 parts by weight, based on 100 parts by weight of the total amount of the rubber component. The BET specific surface area of the silica should be measured according to ISO 5794.

The carbon black used has a DBP oil absorption of 130 cm³/100 g or less. More specifically, HAF (101 cm³/100 g in DBP oil absorption), FEF (115 cm³/100 g in DBP oil absorption), GPF (87 cm³/100 g in DBP oil absorption), SRF (68 cm³/100 g in DBP oil absorption), FT (42 cm³/100 g in DBP oil absorption), or the like is advantageously used as the carbon black. In particular, carbon black with a DBP oil absorption of 80 to 110 cm³/100 g is more preferably used taking into account the balance between the rubber hardness and electrical insulating properties of the resulting rubber shock absorber and the suppression of a decrease in elastic modulus after strain loading. The content of the carbon black in the rubber composition is from 5 to 40 parts by weight, more preferably from 20 to 40 parts by weight, based on 100 parts by weight of the total amount of the rubber component. The DBP oil absorption of the carbon black should be measured according to JIS K 6221.

The formula (1): X/Y≧1.1 may be satisfied, wherein X represents the content of the silica, and Y represents the content of the carbon black. When the formula (1) is satisfied, the rubber hardness of the railcar rubber shock absorber can be increased, and electrical insulating properties and suppression of a decrease in elastic modulus after strain loading can be simultaneously achieved in a more balanced manner. For example, X/Y may have an upper limit of 6 (X/Y≦6).

In an embodiment of the present invention, besides the silica and the carbon black, any other white inorganic filler may be added in an appropriate amount. It should be noted that a white inorganic filler can contribute to the electrical insulating properties of cured rubber but tends to increase the Payne effect and the Mullins effect as its content increases. Taking into account the electrical insulating properties and the suppression of a decrease in elastic modulus after strain loading, therefore, the content of such a white inorganic filler other than the silica and the carbon black is preferably 20 parts by weight or less, more preferably 10 parts by weight or less, based on 100 parts by weight of the total amount of the rubber component.

In addition to the rubber component and the fillers described above including the carbon black and the silica, an additive commonly used in rubber industry, such as a curing agent, a curing accelerator, a silane coupling agent, zinc white, stearic acid, a curing accelerating aid, a curing retarder, an antioxidant, a softening agent such as wax or oil, or a processing aid may be appropriately used and added to the railcar shock absorber rubber composition according to the present invention, as long as the effects of the present invention are not impaired.

The curing agent may be made of sulfur, which is commonly used for rubber, and for example, powdered sulfur, precipitated sulfur, insoluble sulfur, highly-dispersible sulfur, or the like may be used. Taking into account the fatigue resistance and heat resistance or other physical properties of the cured rubber, the curing agent is preferably added in an amount of 0.5 to 3.5 parts by weight, based on 100 parts by weight of the rubber component.

The curing accelerator may be any curing accelerator commonly used for rubber curing, such as a sulfenamide curing accelerator, a thiuram curing accelerator, a thiazole curing accelerator, a thiourea curing accelerator, a guanidine curing accelerator, or a dithiocarbamate curing accelerator. These curing accelerators may be used alone or in any appropriate combination. Taking into account the physical properties or durability of the cured rubber, the curing accelerator is preferably added in an amount of 0.5 to 3.5 parts by weight, based on 100 parts by weight of the rubber component.

The antioxidant may be any antioxidant commonly used for rubber, such as an aromatic amine antioxidant, an amine-ketone antioxidant, a monophenol antioxidant, a bisphenol antioxidant, a polyphenol antioxidant, a dithiocarbamate antioxidant, or a thiourea antioxidant. These antioxidants may be used alone or in any appropriate combination. Taking into account the physical properties or durability of the rubber, the antioxidant is preferably added in an amount of 2 to 5 parts by weight, based on 100 parts by weight of the rubber component.

The cured rubber composition according to the present invention may be obtained by kneading the rubber component, the carbon black, the silica, and other fillers together with additives commonly used in rubber industry, such as a curing agent, a curing accelerator, a silane coupling agent, zinc white, stearic acid, a curing accelerating aid, a curing retarder, an antioxidant, a softening agent such as wax or oil, and a processing aid using a kneading machine commonly used in rubber industry, such as a Banbury mixer, a kneader, or a roll.

The method of blending the respective components may be, but not limited to, any of a method including previously kneading the components other than the sulfur-based components such as sulfur and a curing accelerator to form a master batch, then adding the remainder components, and further kneading them, a method including previously kneading only the rubber component and carbon black to form a master batch, then adding the remainder components, and further kneading them, a method including adding the respective components in any order and kneading them, or a method including adding all components at the same time and kneading them.

A wide variety of railcar rubber shock absorbers can be manufactured by molding the rubber composition according to the present invention into desired shapes. Such rubber shock absorbers, which have high rubber hardness and simultaneously achieve electrical insulating properties and suppression of a decrease in elastic modulus after strain loading, are particularly useful for rail vehicles.

### EXAMPLES

### Preparation of Rubber Compositions

According to the formulation in Table 1, the specified amounts of the components were mixed based on 100 parts by weight of the rubber component and kneaded using a general Banbury mixer, so that each of the rubber compositions of Examples 1 to 3 and Comparative Examples 1 to 4 was obtained. The respective components shown in Table 1 are listed below.

(a) Rubber component: natural rubber RSS#3
(b) Sulfur (5% oil-treated sulfur, manufactured by Hosoi Chemical Industry Co., Ltd.)
(c) Curing accelerator

(A) NS(N-tert-butyl-2-benzothiazolylsulfenamide) (NOCCELER NS-P, manufactured by OUCHI SHINKO CHEMICAL INDUSTRIAL CO., LTD.)

(B) TS (tetramethylthiuram monosulfide) (NOCCELER TS, manufactured by OUCHI SHINKO CHEMICAL INDUSTRIAL CO., LTD.)

(d) Carbon black: HAF carbon black with a DBP oil absorption of 101 cm³/100 g (SEAST 3, manufactured by Tokai Carbon Co., Ltd.)

### (e) Silica

(A) Silica with a BET specific surface area of 210 m²/g (Nipsil AQ, manufactured by Tosoh Silica Corporation)

(B) Silica with a BET specific surface area of 100 m²/g (Nipsil ER, manufactured by Tosoh Silica Corporation)

(f) Silane coupling agent (Si75, manufactured by Degussa AG)

### (g) Antioxidant

(A) N-phenyl-N′-(1,3-dimethylbutyl)-p-phenylenediamine (NOCRAC 6C, manufactured by OUCHI SHINKO CHEMICAL INDUSTRIAL CO., LTD.)

(B) 2,2,4-trimethyl-1,2-dihydroquinoline polymer (NONFLEX RD, manufactured by Seiko Chemical Co., Ltd.)

(h) Zinc oxide (Zinc White No. 3, manufactured by MITSUI MINING & SMELTING CO., LTD.)
(i) Stearic acid (industrial stearic acid, manufactured by Kao Corporation)
(j) Aromatic oil (PROCESS X-140, manufactured by Japan Energy Corporation)

(Evaluations)

The evaluations were performed on a rubber product obtained by heating and curing each rubber composition at 150° C. for 20 minutes using a specific mold.

<Rubber Hardness and Tensile Properties>

According to JIS K 6253, the rubber hardness was measured using a type A durometer. In addition, samples were prepared using JIS No. 3 dumbbell and measured for tensile strength (T_{B} (MPa)) and elongation (E_{B} (%)) according to JIS K 6251. The results are shown in Table 1.

<Electrical Insulating Properties (Volume Resistivity)>

Using ULTRA MEGOHMMETER manufactured by TOA Electronics Ltd., the volume resistivity (Ω·cm) of rubber samples with a shape of 100×100 (mm) and a thickness of 2 (mm) was measured under the conditions of an applied voltage of 500 V, a sheet main electrode outer diameter of 5 cm, and 23° C. The results are shown in Table 1.

<Elastic Modulus After Strain Loading>

Using a spectrometer manufactured by TOYO SEIKI SEISAKU-SHO, LTD., the elastic modulus after strain loading was measured under the measurement conditions below, when the frequency and the initial strain were 10 Hz and 300 μm, respectively.

The storage modulus (E′) is measured in the order of from a strain of 1 μm to a strain of 900 μm, which constitutes a cycle of measurement. In this process, (E′_{(1 μm)}−E′_{(900 μm)}/E′_{(900 μm)} is calculated. Three cycles of measurement are performed, and a difference is calculated between (E′_{(1 μm)}−E′_{(900 μm)}/E′_{(900 μm)} at the first time and (E′_{(1 μm)}−E′_{(900 μm)})/E′_{(900 μm)} at the third time. The difference corresponds to the degree of a decrease in elastic modulus after strain loading. The smaller difference means that the decrease in elastic modulus after strain loading is more suppressed. The results are shown in Table 1.

TABLE 1

| | | | | | | |
|---|---|---|---|---|---|---|
| Comparative | Comparative | | | Comparative | Comparative | |
| Example 1 | Example 2 | Example 1 | Example 2 | Example 3 | Example 4 | Example 3 |

Formulation

| | | | | | | | |
|---|---|---|---|---|---|---|---|
| Natural rubber | 100.0 | 100.0 | 100.0 | 100.0 | 100.0 | 100.0 | 100.0 |
| Zinc white | 5.0 | 5.0 | 5.0 | 5.0 | 5.0 | 5.0 | 5.0 |
| Stearic acid | 2.0 | 2.0 | 2.0 | 2.0 | 2.0 | 2.0 | 2.0 |
| Antioxidant 6C | 2.0 | 2.0 | 2.0 | 2.0 | 2.0 | 2.0 | 2.0 |
| Antioxidant RD | 2.0 | 2.0 | 2.0 | 2.0 | 2.0 | 2.0 | 2.0 |
| Silane coupling agent Si75 | 3.5 | 4.5 | 4.2 | 5.2 | 4.5 | 3.5 | 3.2 |
| Silica (Nipsil AQ) | 42.0 | 57.0 | — | — | 45.0 | 35.0 | — |
| Silica (Nipsil ER) | — | — | 42.0 | 52.0 | — | — | 32.0 |
| Carbon black | 37.0 | 42.0 | 37.0 | 37.0 | 30.0 | 30.0 | 32.0 |
| Aromatic oil | 5.0 | 5.7 | 5.0 | 5.0 | 5.0 | 5.0 | 5.0 |
| Sulfur | 2.50 | 2.50 | 2.50 | 2.50 | 2.50 | 2.50 | 2.50 |
| Curing accelerator NS | 1.00 | 1.00 | 1.00 | 1.00 | 1.00 | 1.00 | 1.00 |
| Curing accelerator TS | 0.10 | 0.20 | 0.20 | 0.20 | 0.20 | 0.20 | 0.20 |
| X/Y | 1.13 | 1.35 | 1.13 | 1.40 | 1.50 | 1.16 | 1.00 |

Physical properties

| Hardness (durometer A) | | 80 | 80 | 74 | 78 | 80 | 74 | 67 |
|---|---|---|---|---|---|---|---|---|
| T_{B} | | 21.8 | 18.1 | 18.6 | 18.4 | 20.3 | 21.8 | 18.7 |
| E_{B} | | 440 | 320 | 390 | 370 | 400 | 420 | 460 |
| Electric resistance (volume resistivity | | 3.12E+12 | <2.50E+06 | 5.20E+12 | 4.75E+12 | 1.18E+13 | 4.06E+13 | 2.06E+11 |
| (Ω · cm) | | | | | | | | |
| (E′_{(1 μm)} − E′_{(900 μm)})/E′_{(900 μm)} | first | 0.727 | 0.610 | 0.649 | 0.702 | 0.720 | 0.579 | 0.525 |
| | time | | | | | | | |
| | third | 0.682 | 0.577 | 0.626 | 0.686 | 0.679 | 0.534 | 0.496 |
| | time | | | | | | | |

| | | | | | | | |
|---|---|---|---|---|---|---|---|
| Difference between the first and | 0.046 | 0.033 | 0.023 | 0.026 | 0.041 | 0.045 | 0.030 |
| third values | | | | | | | |

The results in Table 1 show that the cured rubber obtained from the rubber composition of each of Examples 1 and 2, which contains hydrous silicic acid or wet silica with a BET specific surface area of 100 m²/g, has good electrical insulating properties and is inhibited from undergoing a decrease in elastic modulus after strain loading. In contrast, it is apparent that the cured rubber obtained from the rubber composition of each of Comparative Examples 1 to 4, which contains hydrous silicic acid or wet silica with a BET specific surface area of 210 m²/g, is not inhibited from undergoing a decrease in elastic modulus after strain loading. The electrical insulating properties of the cured rubber obtained from the rubber composition of Example 3 are slightly lower than those of the cured rubber obtained from the rubber composition of Example 1 or 2. It is therefore apparent that X/Y should preferably be 1.1 or more when electrical insulating properties are particularly important.

What is claimed is:

1. A railcar shock absorber rubber composition, comprising:
a diene rubber as a main component;
hydrous silicic acid or wet silica with a BET specific surface area of 70 to 130 m²/g; and
carbon black with a DBP oil absorption of 130 cm³/100 g or less, wherein
30 to 100 parts by weight of the hydrous silicic acid or wet silica and 5 to 40 parts by weight of the carbon black are present based on 100 parts by weight of a total amount of a rubber component.

2. The railcar shock absorber rubber composition according to claim 1, which satisfies the formula (I): X/Y≧1.1, wherein X represents the content of the hydrous silicic acid or wet silica, and Y represents the content of the carbon black.
